(19) United States
(12) Patent Application Publication
(10) Pub. No.: US 2026/0159044 A1
(43) Pub. Date: Jun. 11, 2026

(54) METHOD FOR CLEANING SENSOR, SENSOR CLEANING SYSTEM AND UNMANNED VEHICLE COMPRISING THE SAME

(71) Applicant: AGENCY FOR DEFENSE DEVELOPMENT, Daegu (KR)

(72) Inventors: Kyoung Ho LEE, Daegu (KR); Kyu Hong HAN, Daegu (KR); Jong Min LEE, Daegu (KR)

(21) Appl. No.: 19/327,156

(22) Filed: Sep. 12, 2025

(30) Foreign Application Priority Data
Oct. 31, 2024 (KR) 10-2024-0152802

(51) Int. Cl. B60S 1/56; B05B 12/02; B60S 1/50; G01S 7/497

(52) U.S. Cl. CPC B60S 1/56; B05B 12/02; B60S 1/50; G01S 2007/4977

(57) ABSTRACT

A method for cleaning a sensor, sensor cleaning system and an unmanned vehicle including the same is provided. The sensor cleaning system is included in the unmanned vehicle adapted to be designed for off-road driving and cleans a sensor in operation necessary for the driving of an unmanned vehicle. The sensor cleaning system includes i) a vehicle behavior detecting unit that continuously measures a pitch, roll, and vertical acceleration of the unmanned vehicle; ii) a detergent supply unit that intermittently supplies a detergent for cleaning the sensor when the pitch or the roll is changed from a negative value to a positive value within a predetermined time range and the vertical acceleration falls within a predetermined acceleration range; and iii) a detergent spray unit that is connected to the detergent supply unit and sprays the detergent onto the sensor for cleaning.

### CROSS-REFERENCE TO RELATED APPLICATIONS

This application claims priority to Korean Patent Application Serial No. 10-2024-0152802, filed October 31, 2024, which is incorporated herein by reference in their entirety.

### FIELD OF THE INVENTION

The present invention relates to a method for cleaning a sensor, a sensor cleaning system, and an unmanned vehicle comprising the same. More specifically, the present invention pertains to a method for cleaning a sensor in operation that are necessary for the driving of an unmanned vehicle adapted to travel off-road, to a sensor cleaning system, and to an unmanned vehicle comprising the same.

### BACKGROUND OF THE INVENTION

Recently, the development of vehicles that operate remotely or autonomously has been increasing. The operation of such vehicles is made possible based on sensor information such as a camera or a Lidar attached to the vehicle. These sensors are installed on the exterior of the vehicle and allow for evasive driving by providing information about obstacles and environmental conditions along the driving route.

Meanwhile, since the optical window of the sensor is exposed to foreign substances from the outside, its normal function may become difficult to maintain. That is, foreign substances such as mud, dust, snow, or rain adhering to the optical window of the sensor degrade the detection performance of the sensor. Therefore, air or washer fluid is sprayed onto the optical window to clean the sensor. However, during off-road driving of the vehicle, a large amount of mud may splash and severely contaminate the optical window of the sensor, thus there are limitations to cleaning the sensor.

### SUMMARY OF THE INVENTION

A sensor cleaning system for cleaning a sensor in operation that is required for the driving of unmanned vehicles adapted for off-road travel is provided. In addition, an unmanned vehicle including the aforementioned sensor cleaning system is provided. Furthermore, a method for cleaning a sensor using the aforementioned sensor cleaning system is provided.

A sensor cleaning system according to an embodiment of the present invention included in the unmanned vehicle adapted to be designed for off-road driving cleans a sensor in operation necessary for the driving of an unmanned vehicle. The sensor cleaning system includes i) a vehicle behavior detecting unit that continuously measures a pitch, roll, and vertical acceleration of the unmanned vehicle; ii) a detergent supply unit that intermittently supplies a detergent for cleaning the sensor when the pitch or the roll is changed from a negative value to a positive value within a predetermined time range and the vertical acceleration falls within a predetermined acceleration range; and iii) a detergent spray unit that is connected to the detergent supply unit and sprays the detergent onto the sensor for cleaning.

The predetermined time range may be 1 second or less, and the predetermined acceleration range may be 10 m/s² to 30 m/s². The sensor cleaning system according to an embodiment of the present invention may further include a control unit that is respectively connected to and controls the vehicle behavior detecting unit, the detergent supply unit, and the detergent spray unit. The control unit activates the vehicle behavior detecting unit when automatic mode is input to the control unit. The control unit may deactivate the vehicle behavior detecting unit when manual mode is input to the control unit. The detergent supply unit may intermittently supply the detergent to the detergent spray unit depending on an input of valve mode and duty mode.

The sensor may be installed as a plurality of sensors. The sensor may include, i) a camera that is installed on the front of the unmanned vehicle; and ii) a pair of Lidars that are installed on the front of the unmanned vehicle closer to the wheels of the unmanned vehicle than the camera. The detergent supply unit may include a plurality of detergent supply valves corresponding to the camera and each of the pair of Lidars. The plurality of detergent supply valves may be all opened to supply the detergent to clean the camera and the pair of Lidars when the valve mode is full mode.

The sensor may be installed as a plurality of sensors. The sensor may include i) a camera that is installed on the front of the unmanned vehicle; and ii) a pair of Lidars installed on the front of the unmanned vehicle closer to the wheels of the unmanned vehicle than the camera. The detergent supply unit may include a plurality of detergent supply valves corresponding to the camera and each of the pair of Lidars.

The detergent supply valves corresponding to the camera may be all opened to supply the detergent to clean the camera when the valve mode is basic mode. In the duty mode, a valve closure retention time for at least one of the plurality of detergent supply valves can be selected from a first time, a second time, or a third time, and the first time is shorter than the second time, and the second time is shorter than the third time. The detergent may be air. The detergent supply unit may further include i) an air compressor that generates the air; and ii) a detergent supply tank that supplies the air to the plurality of valves.

If a pressure in the detergent supply tank drops below a predetermined pressure after the detergent supply valve is opened in the manual mode, the detergent supply valve may be closed, and the air compressor may replenish the air in the detergent supply tank until the maximum set pressure of the detergent supply tank is reached.

An unmanned vehicle according to an embodiment of the present invention includes the aforementioned sensor cleaning system.

A method for cleaning a sensor according to an embodiment of the present invention included in the unmanned vehicle adapted to be designed for off-road driving cleans a sensor in operation necessary for the driving of an unmanned vehicle. The unmanned vehicle includes a vehicle behavior detecting unit, a detergent supply unit, a detergent spray unit and a control unit. The method for cleaning a sensor includes a first step of activating the vehicle behavior detecting unit; a second step that the vehicle behavior detecting unit continuously measures pitch, roll, and vertical acceleration of the unmanned vehicle; a third step that the control unit determines whether the condition is met in which the pitch or the roll is changed from a negative value to a positive value within a predetermined time range and the vertical acceleration falls within a predetermined acceleration range; a fourth step that the detergent supply unit intermittently supplies the detergent to clean the sensor if the condition is met; and a fifth step that the detergent spray unit sprays the detergent onto the sensor to clean the sensor. In the third step, the predetermined time range may be 1 second or less, and the predetermined acceleration range may be 10 m/s² to 30 m/s².

A method for cleaning a sensor according to an embodiment of the present invention may further includes a sixth step of deactivating the vehicle behavior detecting unit when a manual mode is input to the control unit; a seventh step that the detergent supply unit intermittently supplies the detergent to clean the sensor according to the input of valve mode and duty mode; and an eighth step that the detergent spray unit sprays the detergent onto the sensor to clean the sensor.

The sensor may include i) a camera installed on the front of the unmanned vehicle; and ii) a pair of Lidars installed on the front of the unmanned vehicle closer to the wheels of the unmanned vehicle than the camera. The detergent supply unit may include a plurality of detergent supply valves corresponding to the camera and each of the pair of Lidars. In the seventh step, the plurality of detergent supply valves may be all opened to supply the detergent to the camera and the pair of Lidars if the valve mode is full mode.

The sensor may include i) a camera installed on the front of the unmanned vehicle; and ii) a pair of Lidars installed on the front of the unmanned vehicle closer to the wheels of the unmanned vehicle than the camera. The detergent supply unit may include a plurality of detergent supply valves corresponding to the camera and each of the pair of Lidars. In the seventh step, detergent supply valves corresponding to the camera may be opened to supply the detergent to the camera if the valve mode is basic mode.

In the duty mode, the valve closure retention time for at least one of the plurality of detergent supply valves can be selected from a first time, a second time, or a third time, and the first time is shorter than the second time, and the second time is shorter than the third time. The detergent supply unit may further includes i) a detergent supply valve corresponding to the sensor; and ii) a detergent supply tank that supplies the detergent to the detergent supply valve. In the seventh step, an open time of the detergent supply valve that intermittently supplies the detergent may include i) a first open time corresponding to an upper limit to a maximum allowable pressure of the detergent supply tank; ii) a second open time corresponding to a lower limit to an upper limit of the detergent supply tank; and iii) a third open time corresponding to a minimum allowable pressure to a lower limit of the detergent supply tank. The third open time may be greater than or equal to the second open time, and the second open time is greater than or equal to the first open time.

The second open time may be inversely proportional to the pressure of the detergent supply tank. The second open time may be set to be constant. The detergent supply unit may further include i) a detergent supply valve corresponding to the sensor; and ii) a detergent supply tank that supplies the detergent to the detergent supply valve. In the seventh step, the detergent supply valve may be closed if the pressure of the detergent supply tank drops below the lower limit of the detergent supply tank after the detergent supply valve is opened.

By using the sensor cleaning system, unmanned vehicles can perform their missions smoothly even during off-road driving. In addition, by employing a method for cleaning a sensor optimized for the characteristics of off-road driving, the lifespan of the sensors can be improved. When mud adheres to the sensors, it tends to harden and stick to the sensor, making it difficult to remove, but this problem can be resolved by immediately removing the mud splashed from ditches using the sensor cleaning system. Unnecessary loss of air filled in the detergent supply tank can be suppressed. As a result, the flow rate of the detergent sprayed through the nozzle can be maintained at an appropriate level for sensor cleaning, thereby extending the available time of the detergent supply tank while simultaneously reducing the number of operations or continuous operating time of the air compressor. By controlling the open time of the detergent supply valve according to the pressure of the detergent supply tank, the cleaning performance of the sensor can be maintained while extending the available time of the detergent supply tank. As a result, the lifespan of the air compressor can be extended. In addition, during remote or autonomous driving of unmanned vehicles in rough terrain, sensor contamination caused by muddy water can be immediately resolved according to the operator’s mode setting. Therefore, early removal of high-viscosity foreign substances adhering to the sensor can prevent sensor malfunction.

### BRIEF DESCRIPTION OF THE DRAWINGS

FIG. 1 is a schematic diagram of an unmanned vehicle according to an embodiment of the present invention.

FIG. 2 is a schematic block diagram of a sensor cleaning system included in the unmanned vehicle of FIG. 1.

FIG. 3 is a schematic side view of the driving state of the unmanned vehicle of FIG. 1.

FIG. 4 is a schematic front view of the driving state of the unmanned vehicle of FIG. 1.

FIG. 5 is a schematic diagram of a detergent supply unit and a detergent spray unit included in the sensor cleaning system of FIG. 2.

FIG. 6 is a schematic hardware configuration diagram of the control unit of FIG. 2.

FIGS. 7A to 7C are schematic flowcharts of method for cleaning a sensor according to an embodiment of the present invention.

FIGS. 8A to 8C are various duty cycle graphs of the detergent supply valve corresponding to the method for cleaning a sensor of FIGS. 7A to 7C, respectively.

FIG. 9 is a graph of the open time of the detergent supply valve with respect to the pressure of the detergent supply tank in the method for cleaning a sensor according to an embodiment of the present invention.

FIG. 10 is another graph of the open time of the detergent supply valve with respect to the pressure of the detergent supply tank in the method for cleaning a sensor according to an embodiment of the present invention.

### DETAILED DESCRIPTION

Below, based on the attached drawings, an embodiment of the present disclosure will be described in detail so that those of ordinary skill in the technical field to which the present disclosure pertains can easily implement it. However, the present disclosure may be embodied in various different forms and is not limited to the embodiments described herein. In addition, in order to clearly explain the present disclosure in the drawings, parts irrelevant to the description have been omitted, and throughout the entire specification, similar reference numerals have been assigned to similar parts.

In the specification, when a part is said to "include" a certain component, unless otherwise expressly stated to the contrary, this does not exclude other components but rather means that other components may also be included. In addition, terms such as "… unit," "… device," "… module," and the like described in the specification refer to units that process at least one function or operation.

In this specification, terms including ordinals such as first, second, etc., may be used to describe various components, but these components are not limited by such terms. These terms are used solely for the purpose of distinguishing one component from another. For example, without departing from the scope of the present disclosure, the first component may be referred to as the second component, and similarly, the second component may be referred to as the first component.

In the flowchart described with reference to the drawings in this specification, the order of operations may be changed, several operations may be combined, certain operations may be divided, and specific operations may not be performed.

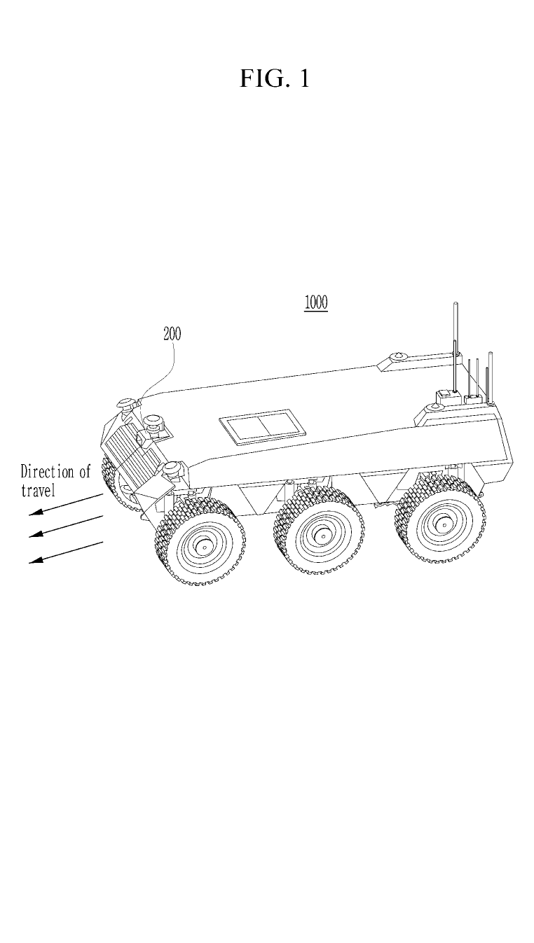

FIG. 1 schematically shows an unmanned vehicle 1000 according to an embodiment of the present invention. The unmanned vehicle 1000 of FIG. 1 is merely for illustrating the present invention, and the present invention is not limited thereto. Therefore, the unmanned vehicle 1000 may be otherwise modified. The unmanned vehicle 1000 may be used for military purposes.

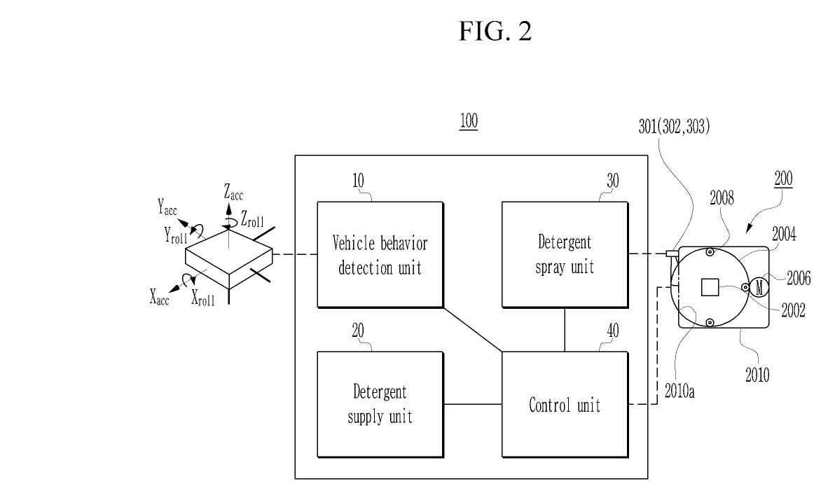

As shown in FIG. 1, the unmanned vehicle 1000 includes a sensor 200 for driving in the direction of travel. The sensor 200 is installed at the front of the unmanned vehicle 1000 to enable its operation. The sensor 200 may be a LiDAR or a camera. LiDAR uses laser pulses to measure distances and provides a precise 3D map of the surrounding environment through object detection, obstacle avoidance, and terrain mapping. The camera provides visual data by capturing the surroundings, detecting lanes, and recognizing objects when the unmanned vehicle 1000is driving on the road. LiDAR provides the depth necessary for decision-making during autonomous driving of the unmanned vehicle 1000, while the camera offers visual data to complement it. Therefore, if the sensor 200 becomes contaminated, it may be difficult for the unmanned vehicle 1000 to operate, and a sensor cleaning system 100 capable of removing contaminants from the sensor 200 is required. This will be explained in detail with reference to FIG. 2.

FIG. 2 schematically illustrates the block structure of the sensor cleaning system 100 included in the unmanned vehicle 1000 of FIG. 1. The structure of the sensor cleaning system 100in FIG. 2 is merely exemplary of the present invention and is not limited thereto. Therefore, the structure of the sensor cleaning system 100 may be variously modified.

The sensor cleaning system 100of FIG. 2 is connected to the sensor 200 of FIG. 1 and cleans the sensor 200. As a result, information necessary for the driving of the unmanned vehicle 1000 of FIG. 1 can be smoothly obtained from the sensor 200. The sensor cleaning system 100 can clean only the sensor 200 that is in operation. That is, sensors that are not in use are not related to the driving of the unmanned vehicle 1000, thereby sensors 200 that are not operating may not be cleaned in order to reduce unnecessary energy consumption.

As illustrated in FIG. 2, the sensor cleaning system 100 includes a vehicle behavior detection unit 10, a detergent supply unit 20, a detergent spray unit 30, and a control unit 40 connected to each other. In addition, the sensor cleaning system 100 may further include other components.

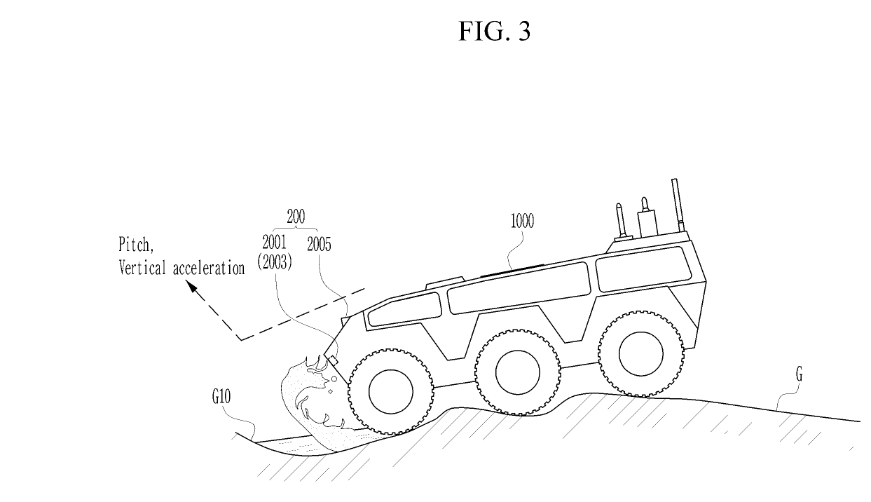

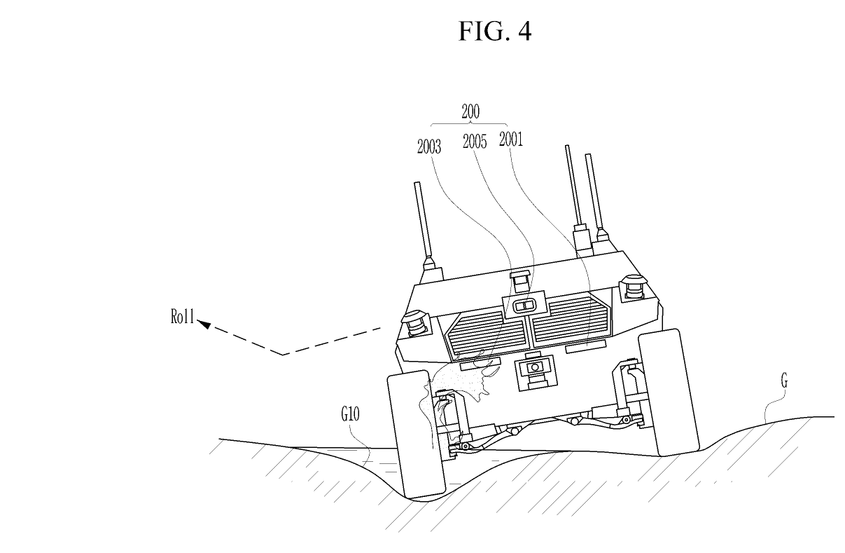

The vehicle behavior detection unit 10continuously measures pitch, roll, and vertical acceleration of the unmanned vehicle 1000(as shown in FIG. 1, the same applies hereinafter). That is, the vehicle behavior detection unit 10continuously measures the pitch, roll, and vertical acceleration of the unmanned vehicle 1000, thereby allowing determination of whether the unmanned vehicle 1000 is in a state of receiving a large impact while passing through a puddle during off-road driving. Specifically, the vehicle behavior detection unit 10can measure the angular velocity and linear acceleration of the unmanned vehicle 1000 through the IMU, Inertial Measurement Unit 101. In other words, the angular velocity and linear acceleration of the unmanned vehicle 1000 are measured by using the gyroscope and accelerometer embedded in the IMU 101. This will be explained in more detail with reference to FIGS. 3 and 4.

FIG. 3 schematically illustrates a side view of the driving state of the unmanned vehicle 1000 of FIG. 1. The driving state of the unmanned vehicle 1000 in FIG. 3 is intended merely as an example of the present invention, and the present invention is not limited thereto.

As illustrated in FIG. 3, the unmanned vehicle 1000 can pass through a puddle G10 of muddy water while driving off-road G. In this case, the muddy water may splash and contaminate the sensor 200. The sensor 200 includes a pair of LiDARs 2001 and 2003 and a camera 2005. Both the pair of LiDARs 2001 and 2003 and the camera 2005 are installed at the front of the unmanned vehicle 1000. The pair of LiDARs 2001 and 2003 are installed closer to the wheels of the unmanned vehicle 1000 than the camera 2005. Therefore, the pair of LiDARs 2001 and 2003 are more likely to be contaminated by splashing muddy water than the camera 2005.

The IMU 101 embedded in the unmanned vehicle 1000 (as shown in FIG. 2, same hereinafter) continuously measures the pitch and vertical acceleration of the unmanned vehicle 1000. As shown by the dotted line in FIG. 3, pitch means the rotation about the lateral axis of the unmanned vehicle 1000, measuring the degree to which the unmanned vehicle 1000 tilts forward or backward. When the unmanned vehicle 1000 enters the puddle G10, it tilts forward and the pitch takes on a negative value. In addition, when the unmanned vehicle 1000 exits the puddle G10, it tilts backward and the pitch takes on a positive value. Therefore, whether the unmanned vehicle 1000 has passed through the puddle G10 can be determined by the pitch changing from a negative value to a positive value. If the pitch of the unmanned vehicle 1000 continues to show a negative value, it may be in a state of continuing to descend on a slope rather than passing through a puddle, thereby the change in pitch as described above is checked to distinguish this. Such a change in pitch, considering the traveling speed of the unmanned vehicle 1000, can be based on a standard of equal to or less than 1 second. That is, if the pitch of the unmanned vehicle 1000 changes from a negative value to a positive value within 1 second, it can be regarded as the unmanned vehicle 1000 passing through the puddle G10. Since pitch change data in a range exceeding 1 second may include noise, it is checked whether the pitch changes within the above-mentioned time setting.

For a more accurate determination, the vertical acceleration of the unmanned vehicle 1000 can be measured by the IMU 101. Vertical acceleration refers to the acceleration that occurs when the unmanned vehicle 1000 increases or decreases in height while passing over the puddle G10. When the unmanned vehicle 1000 passes over a puddle G10, acceleration is generated as it tilts forward or leans backward. Therefore, by measuring the vertical acceleration of the unmanned vehicle 1000, it is possible to determine whether the unmanned vehicle 1000 is passing over a puddle G10. For example, this range of vertical acceleration may be from 10m/s² to 30m/s². If the vertical acceleration is too small, it may be the case that the unmanned vehicle 1000 is traveling on flat terrain. Conversely, if the vertical acceleration is too large, the unmanned vehicle 1000 may be in a jumping state or in a rough landing state. Therefore, the vertical acceleration is set within the aforementioned range.

Meanwhile, in addition, it is possible to check whether the unmanned vehicle 1000 passes through the puddle G10 by using the roll of the unmanned vehicle 1000. This will be explained in more detail with reference to FIG. 4.

FIG. 4 schematically illustrates a front view of the driving state of the unmanned vehicle 1000 of FIG. 1. The driving state of the unmanned vehicle 1000 in FIG. 4 is merely for the purpose of exemplifying the present invention, and the present invention is not limited thereto. In addition, since the unmanned vehicle 1000 of FIG. 4 is the same as the unmanned vehicle 1000 of FIG. 3, the same reference numerals are used for the same parts, and detailed descriptions thereof are omitted. Meanwhile, in FIG. 4, the positions of the camera 2005and the pair of LiDARs (2001 and 2003) are merely for the purpose of exemplifying the present invention, and the present invention is not limited thereto. Accordingly, the positions of the camera 2005and the pair of LiDARs (2001 and 2003) may be variously modified.

As shown by the dotted arrow in FIG. 4, the roll refers to the left or right tilt of the unmanned vehicle 1000 when it leans to either side. Therefore, as the unmanned vehicle 1000 passes through the puddle G10, it tilts forward and then tilts backward, so the roll can change from a negative value to a positive value. In other words, it can be determined that the unmanned vehicle 1000 has passed through the puddle G10 when the roll changes from a negative value to a positive value. This change in the roll can be based on a standard of equal to or less than one second, considering the driving speed of the unmanned vehicle 1000. That is, if the roll of the unmanned vehicle 1000 changes from a negative value to a positive value within one second, it can be regarded as the unmanned vehicle 1000 passing through the puddle G10. Since noise may be included in the roll change data in a range exceeding one second, it is necessary to check whether the roll changes within the aforementioned time setting.

Returning to FIG. 2, the detergent supply unit 20 intermittently supplies a detergent for cleaning the sensor. That is, if the pitch or roll changes from a negative value to a positive value within the aforementioned time range, and the vertical acceleration falls within the aforementioned acceleration range, it can be regarded that the unmanned vehicle 1000 is passing through a puddle, thereby the sensor is cleaned using the detergent. The detergent may be air, water, or a chemical substance. By using a detergent suitable for the situation, the sensor can be smoothly cleaned.

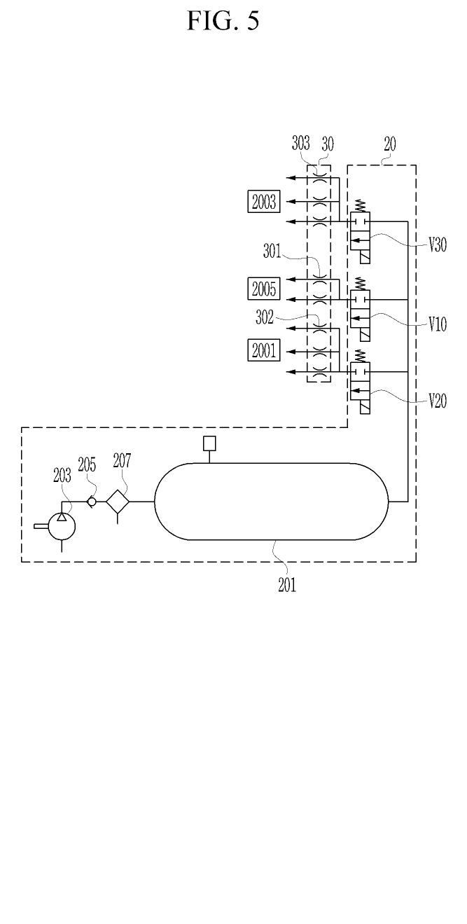

The detergent spray unit 30 sprays the detergent onto the sensor to clean the sensor. As a result, mud or muddy water splashed from puddles can be immediately removed, preventing soil from adhering to the sensor and thereby avoiding sensor malfunction during operation. This will be explained in more detail with reference to FIG. 5.

FIG. 5 schematically illustrates the detergent supply unit 20 and the detergent spray unit 30 included in the sensor cleaning system 100 of FIG. 2. The structure of the detergent supply unit 20 and the detergent spray unit 30 in FIG. 5 is merely exemplary of the present invention, and the present invention is not limited thereto. Therefore, the structures of the detergent supply unit 20 and the detergent spray unit 30 may be variously modified. FIG. 5 exemplifies the use of air as the detergent.

As illustrated in FIG. 5, the detergent supply unit 20 includes a detergent supply tank 201, an air compressor 203, a check valve 205, a dryer 207, and detergent supply valves V10, V20 and V30. In addition, the detergent supply unit 20 may further include other components such as tubes.

As illustrated in FIG. 5, the air compressor 203 generates air used for cleaning the sensors of the unmanned vehicle 1000. Air needs to be used not only for the sensor cleaning system but also at other locations. Therefore, if the air consumption of the sensor cleaning system is high, other components of the unmanned vehicle 1000 that require air may not function properly, which can adversely affect the driving of the unmanned vehicle 1000. Accordingly, it is necessary to minimize the air consumption of the sensor cleaning system.

The dryer 207 removes moisture contained in the air generated by the air compressor 203 by heating it. Since the moisture contained in the air can cause malfunction in the device supplied with the air, the moisture is removed using the dryer 207. If air flows back from the dryer 207 to the air compressor 203, the moisture may cause a failure in the air compressor 203. Therefore, a check valve 205 is used to prevent air from flowing back from the dryer 207 to the air compressor 203.

The detergent supply tank 201 stores air from which moisture has been removed. The air pressure in the detergent supply tank 201 is maintained at a high level. Therefore, when the valves V10, V20 and V30 are opened, high-pressure air can pass through the detergent supply valves V10, V20 and V30 and then be sprayed onto the sensor through the nozzle 301. To improve cleaning efficiency, the air is supplied intermittently. That is, air is supplied by repeatedly opening and closing the detergent supply valves V10, V20 and V30.

The detergent supply valve V10 corresponds to the camera 2005 while the detergent supply valves V20 and V30 correspond to the pair of riders 2001 and 2003, respectively. The detergent spray unit 30includes nozzles 301, 302 and 303. The nozzles 301, 302 and 303 correspond respectively to the detergent supply valves V10, V20 and V30. A solenoid valve, which is an electronically controlled on/off valve, can be used as the detergent supply valves V10, V20 and V30.

Returning to FIG. 2, the sensor 200 connected to the detergent spray unit 30 includes a visual sensor 2002, optical window 2004, motor 2006, bearing 2008, and casing 2010. In addition, the sensor 200 may further include other components. The structure of the sensor 200 in FIG. 2 is merely an example to illustrate the present invention and is not limited thereto. Therefore, the structure of the sensor 200 may be modified in various ways.

As shown in FIG. 2, the optical window 2004 surrounds the visual detection element 2002 as a lens. The inner surface of the optical window 2004 is in contact with the bearing 2008 while the outer surface of the optical window 2004 is in contact with the motor 2006. As a result, the optical window 2004 can rotate by driving the motor 2006. The casing 2010 houses the optical window 2004. An opening 2010a is formed in the casing 2010 to expose the optical window 2004 in the forward direction. Nozzles 301, 302 and 303 are installed in the casing 2010. Therefore, cleaning fluid can be sprayed from the nozzles 301, 302 and 303 to clean the exposed surface of the optical window 2004. Since the optical window 2004 rotates, it is possible to clean the entire surface of the optical window 2004, not just a part of it. Through cleaning, foreign substances are removed from the sensor 200.

Meanwhile, the vehicle behavior detection unit 10 operates not in manual mode but in automatic mode. That is, the vehicle behavior detection unit 10 is activated in automatic mode and deactivated in manual mode by the control unit 40. Only one of the automatic mode or manual mode can be selected by the control unit 40. In other words, the automatic mode and manual mode are mutually exclusive in order to prevent malfunction due to interference between devices. In an unmanned vehicle, it is usually used in manual mode, but when the unmanned vehicle needs to drive on an off-road with puddles, it can be switched to automatic mode to utilize the vehicle behavior detection unit 10.

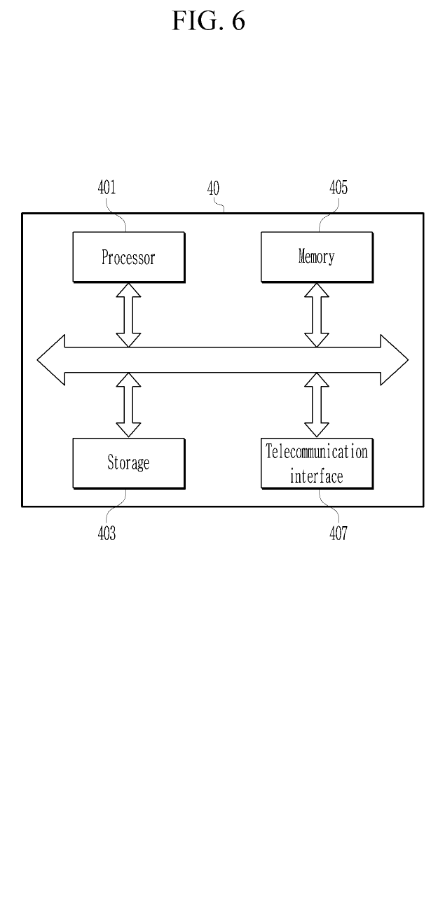

The control unit 40 transmits a control command to operate the detergent supply unit 20 when the pitch or roll and vertical acceleration of the unmanned vehicle measured by the vehicle behavior detection unit 10 satisfy specific conditions. The structure of such a control unit 40 will be described in more detail with reference to FIG. 6.

FIG. 6 schematically illustrates the hardware structure of the control unit 40 included in the sensor cleaning system 100 of FIG. 2. The structure of the control unit 40 in FIG. 6 is merely exemplary of the present invention and the present invention is not limited thereto. Therefore, the structure of the control unit 40 in FIG. 6 may be modified in various ways.

As shown in FIG. 6, the control unit 40 may be implemented with at least one computing device and can execute a computer program containing instructions described to perform operations according to one embodiment. The hardware of the control unit 40 includes at least one processors 401, at least one storage devices 403, at least one memories 405, and at least one communication interfaces 407. These can be interconnected via a bus. In addition, the control unit 40 may include hardware such as input devices and output devices. Furthermore, the control unit 40 may be equipped with various software including an operating system capable of running programs.

The processor 401 controls the operation of the control unit 40. The processor 401 may be various types of microprocessors that process instructions included in a program. For example, the processor 401 may be a CPU (Central Processing Unit), MPU (Micro Processor Unit), MCU (Micro Controller Unit), or GPU (Graphic Processing Unit), among others. The storage 403 stores various data and programs required to execute operations according to one embodiment. The memory 405 loads the program so that instructions described to execute operations according to one embodiment can be processed by the processor 401. For example, the memory 405 may be ROM (read only memory), RAM (random access memory), or the like. The communication interface 407, as a wired/wireless communication module, can interoperate with an external database through a wired or wireless network.

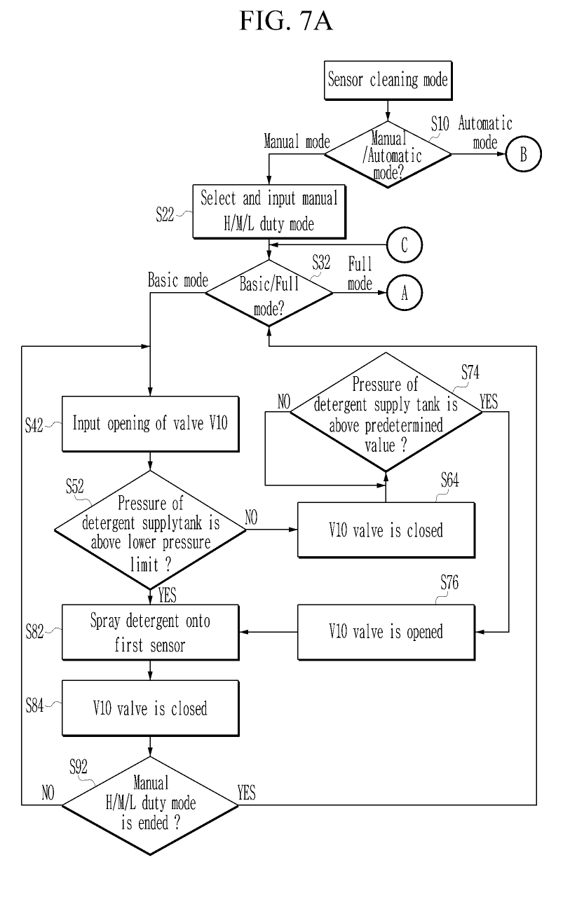

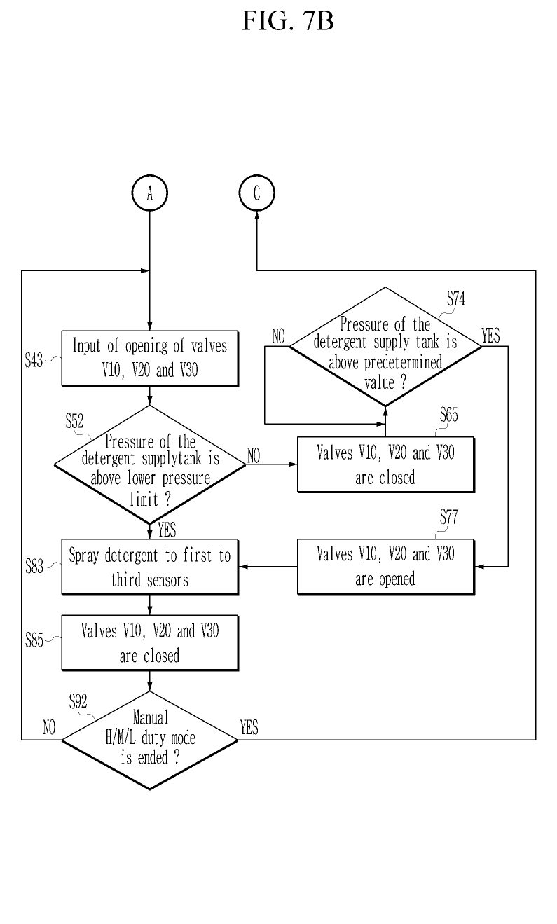

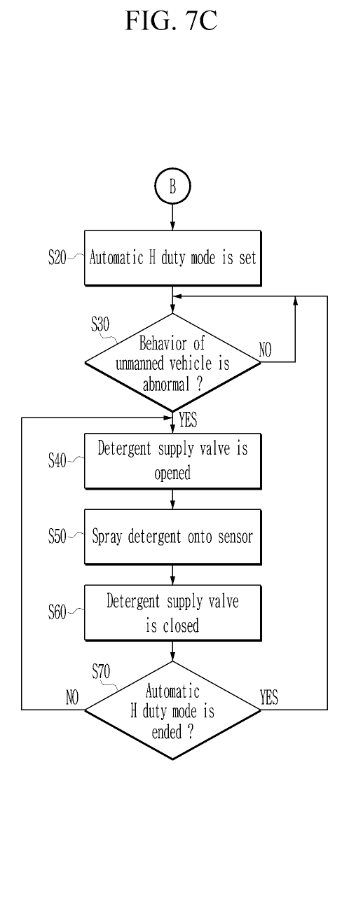

FIGS. 7A to 7C schematically illustrate flowcharts of the method for cleaning a sensor according to an embodiment of the present invention. FIG. 7A schematically shows the operational flowchart when the method for cleaning a sensor is in manual mode and valve mode as the basic mode; FIG. 7B schematically shows the operational flowchart when the method for cleaning a sensor is in manual mode and valve mode as the full mode; and FIG. 7C schematically shows the operational flowchart when the method for cleaning a sensor is in automatic mode. The method for cleaning a sensor shown in FIGS. 7A to 7C are merely exemplary of the present invention, and the present invention is not limited thereto. Therefore, the method for cleaning a sensor may be modified in different ways.

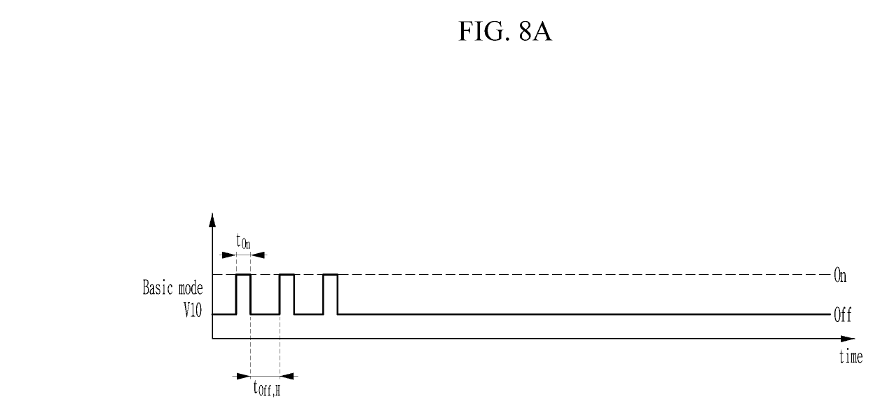

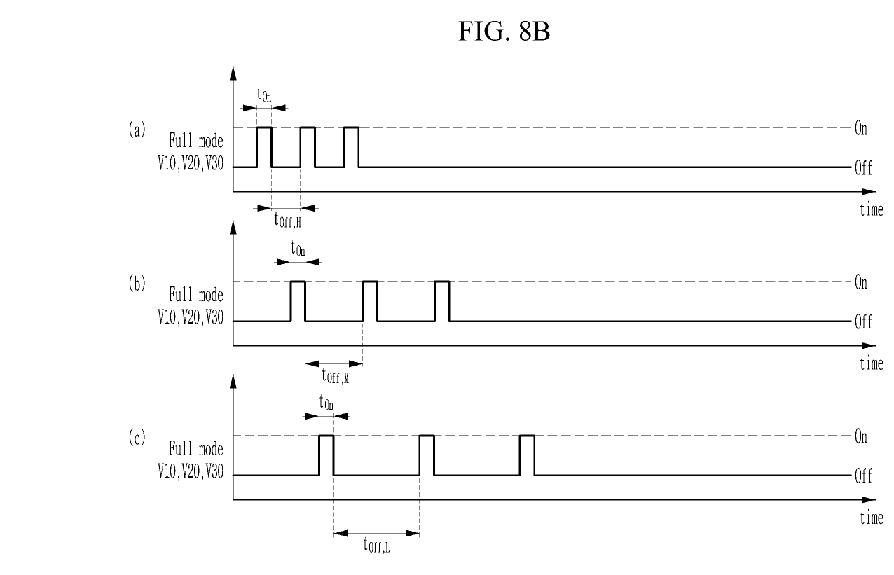

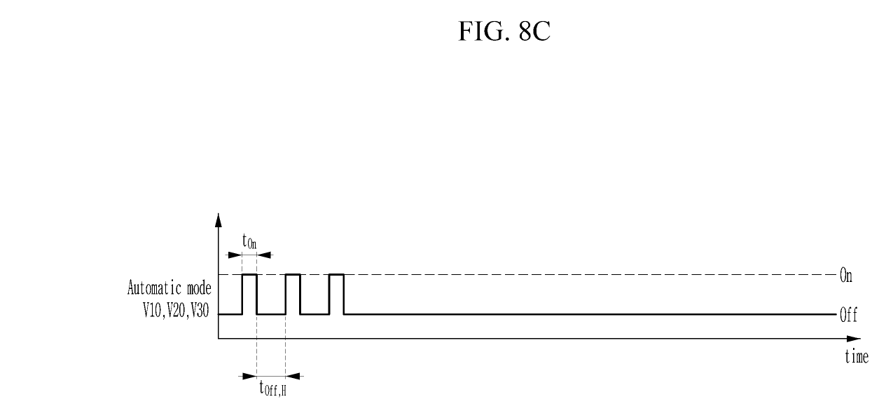

Meanwhile, FIGS. 8A to 8C show various duty cycle graphs of the detergent supply valve in each of the method for cleaning a sensor of FIGS. 7A to 7C. More specifically, FIG. 8A corresponds to FIG. 7A and shows the duty cycle graph in the case where the manual mode and valve mode are the basic modes; FIG. 8B corresponds to FIG. 7B and shows the duty cycle graph in the case where the manual mode and valve mode are in full mode, and FIG. 8C corresponds to FIG. 7C and shows the duty cycle graph in the case of the automatic mode. Hereinafter, the method for cleaning a sensor of FIGS. 7A to 7C will be described in detail with reference to FIGS. 8A to 8C.

As shown in FIG. 7A, when entering the sensor cleaning mode, in step S10, either the manual mode or the automatic mode is first selected. That is, the manual mode or automatic mode is input into the control unit, and the operation of each mode is performed in sequence. The manual mode and automatic mode can be performed automatically according to the driving situation of the unmanned vehicle, or can be input by the operator of the unmanned vehicle.

If manual mode is selected in step S10, then in step S22, the manual H/M/L duty mode is selected and entered. That is, based on the user’s input, one of the manual H/M/L duty modes is selected. In these duty modes, the valve closure retention time for the detergent supply valve can be selected from among the first time, the second time, or the third time. Here, when the H duty mode corresponds to the first time, the M duty mode to the second time, and the L duty mode to the third time, the first time is shorter than the second time, and the second time is shorter than the third time. In other words, the valve closure retention time for the detergent supply valve is set in the order of first time < second time < third time.

That is, as shown in FIG. 8A, the manual mode may be implemented differently depending on the valve mode selected for the detergent supply valve, and in the basic mode, only the detergent supply valve V10 is operated. That is, when only the degree of obstruction of the camera 2005's view is an issue during the operation of the unmanned vehicle, only the detergent supply valve V10 is operated, and by using the H duty mode, which has the shortest off time, the camera 2005can be cleaned.

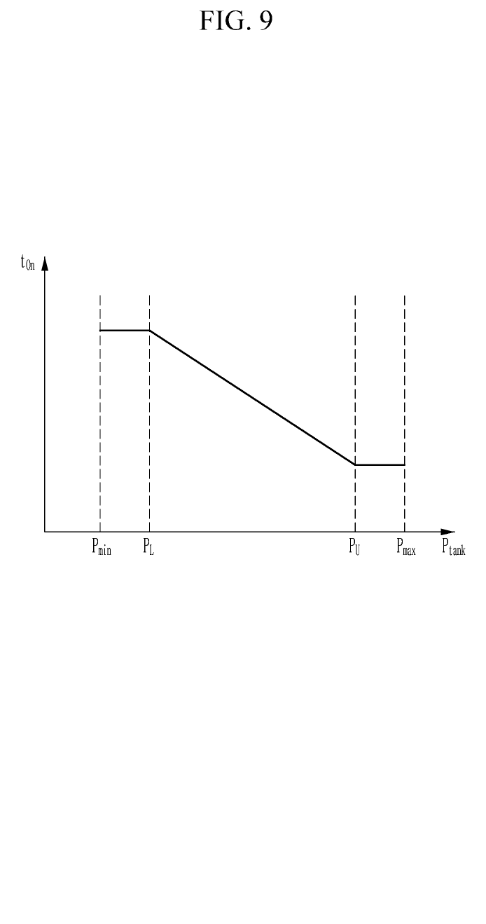

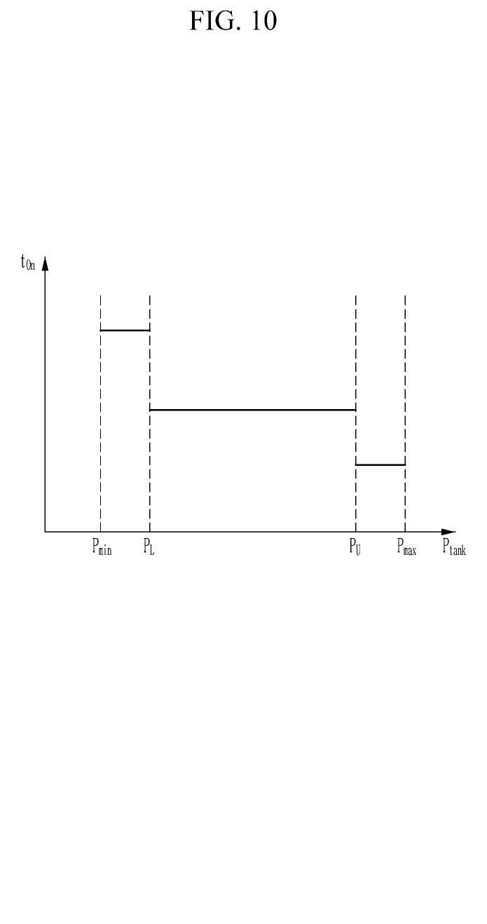

Returning to FIG. 7A, in step S42, the opening of the detergent supply valve V10 is input according to the previous selection. Next, in step S52, it is checked whether the pressure in the detergent supply tank is equal to or above the lower pressure limit. That is, if the pressure in the detergent supply tank is too low, it is not possible to smoothly carry out cleaning with the detergent. Therefore, in step S64, it is necessary to close the detergent supply valve V10 and wait until the pressure in the detergent supply tank recovers to an appropriate level. The pressure in the detergent supply tank is related to the open time of the detergent supply valve. This will be described later with reference to FIGS. 9 and 10.

Since the detergent supply valve is closed in step S64, the pressure of the detergent supply tank can be increased. In addition, in step S74, it is checked whether the pressure of the detergent supply tank is equal to or above the predetermined value. The predetermined value is sufficient as long as it is a pressure at which the detergent supply tank can operate normally in the subsequent process. For example, it may be the upper pressure limit, or the median value between the lower and upper pressure limits. If, in step S74, the pressure of the detergent supply tank is less than the predetermined value, it waits until the pressure of the detergent supply tank rises equal to or above the predetermined value. If the detergent is air, this can be achieved by operating an air compressor to generate and supply air.

If, in step S74, the pressure in the detergent supply tank equal to or exceeds the predetermined value, proceed to step S76 and open the detergent supply valve. Then, in step S52, as in the case where the pressure in the detergent supply tank is equal to or above the lower pressure limit, proceed to step S82 and spray the detergent onto the first sensor, that is, the camera.

Next, in step S84, the detergent supply valve V10 is closed according to the intermittent operation of the detergent supply valve. As a result, the first cleaning of the sensor with the detergent is temporarily suspended.

In step S92, it is checked whether the manual H/M/L duty set in step S22 has ended. If the manual H/M/L duty has not ended, the process proceeds again to step S42 and repeats the aforementioned procedures. The step S92 may be performed differently for each sensor.

Meanwhile, if the manual H/M/L duty has ended in step S92, the process proceeds to step S32, where either the basic mode or full mode is selected. This process of the manual mode can be terminated when switching to the automatic mode. Conversely, the automatic mode can also be terminated when switching to the manual mode.

FIG. 7B is a schematic operational flowchart of the method for cleaning a sensor in the case where the manual mode and the valve mode are in full mode. Since FIG. 7B is similar to FIG. 7A, the same reference numerals are used for the same parts, and a detailed description thereof will be omitted.

FIG. 7B shows the case where the valve mode is in full mode, and all detergent supply valves V10, V20 and V30 are operated. That is, if it is determined that not only the camera but also the LiDAR near the wheels of the unmanned vehicle is heavily contaminated, the full mode is selected and all detergent supply valves V10, V20 and V30 are opened, allowing not only the camera but also the LiDAR to be cleaned.

That is, in step S43, the opening of all detergent supply valves V10, V20 and V30 is input, and accordingly, in step S83, the detergent is sprayed onto the first sensor to the third sensor, that is, the camera and the pair of LiDARs. Then, in step S85, the detergent supply valves V10, V20 and V30 are closed. Depending on the pressure of the detergent supply tank, all detergent supply valves V10, V20 and V30 may be closed in step S65, or all detergent supply valves V10, V20 and V30 may be opened in step S77. This is the same as when the valve mode of FIG. 7A described above is the basic mode.

Meanwhile, referring to FIG. 8B, which corresponds to the duty cycle of FIG. 7B, (a) in FIG. 8B is the H duty mode, (b) is the M duty mode, and (c) is the L duty mode. By selecting these duty modes, the first through third sensors can be cleaned. The valve closure retention time (t_{off}, H) of the detergent supply valve in the H duty mode is shorter than the valve closure retention time (t_{off}, M) in the M duty mode. In addition, the valve closure retention time (t_{off}, M) in the M duty mode is shorter than the valve closure retention time (t_{off}, L) in the L duty mode. That is, by appropriately setting the closure retention time, i.e., the OFF time, of the detergent supply valve, the sensors can be cleaned more efficiently. Meanwhile, the ON time, i.e., the opening retention time, of the detergent supply valve may be constant regardless of the duty mode.

In the automatic mode illustrated in FIG. 7C, the H duty mode is automatically set in step S20. That is, the duration for which the detergent supply valve remains closed is automatically set. In automatic mode, the detergent supply valves V10, V20 and V30 are turned ON/OFF according to the H duty mode. Specifically, if the data measured by the vehicle behavior detection unit determines that the unmanned vehicle is passing through a puddle, the detergent supply valves V10, V20 and V30 are promptly and intermittently operated to spray the detergent onto the first to third sensors. Through this process, any foreign substances such as muddy water that adhere to the sensors are immediately removed, ensuring that the sensors can operate smoothly.

In step S30, it is determined whether abnormal behavior of the unmanned vehicle is detected. This is accomplished by measuring the pitch, the roll and the vertical acceleration of the unmanned vehicle, as described above. If abnormal behavior of the unmanned vehicle is detected, that is, if it is determined that the unmanned vehicle is passing through a pothole, the process proceeds to step S40. If abnormal behavior of the unmanned vehicle is not detected, the system continues to monitor whether there is any abnormal behavior of the unmanned vehicle.

In step S40, the detergent supply valve is opened by the command of the control unit, and detergent is supplied. The detergent with high pressure is discharged from the detergent supply tank and passes through the detergent supply valve.

Next, in step S50, a detergent is sprayed onto the sensor. As a result, muddy water or mud adhering to the sensor can be removed.

Then, in step S60, the detergent supply valve is closed. Therefore, the detergent supply line can be maintained at high pressure again.

In step S70, it is checked whether the predetermined automatic H duty mode has ended. If the automatic H duty mode has not ended, the process returns to step S40 and the aforementioned procedure is repeated. That is, as shown in FIG. 8C, the detergent can be sprayed intermittently three times. If the automatic H duty mode has ended, the process returns to step S30 to detect whether there is any abnormal behavior of the unmanned vehicle.

FIG. 9 schematically shows a graph of the open time of the detergent supply valve with respect to the pressure of the detergent supply tank in the method for cleaning a sensor according to one embodiment of the present invention. The graph in FIG. 9 is provided merely for illustration of the present invention, and the present invention is not limited thereto.

As shown in FIG. 9, the open time of the detergent supply valve, that is, the ON time (tₒₙ), is linearly adjusted according to the pressure (Pₜₐₙₖ) of the detergent supply tank. The pressure (Pₜₐₙₖ) of the detergent supply tank can be classified, in order of magnitude, as the minimum allowable pressure (Pₘᵢₙ), the lower pressure limit (P_{L}), the upper pressure limit (P_{U}), and the maximum allowable pressure (Pₘₐₓ). Here, the minimum allowable pressure (Pₘᵢₙ) corresponds to the starting pressure of the air compressor, and the maximum allowable pressure (Pₘₐₓ) corresponds to the stopping pressure of the air compressor. The lower pressure limit (P_{L}) and the upper pressure limit (P_{U}) refer to the minimum and maximum values of the pressure during the actual operation of the detergent supply tank, respectively, while the minimum allowable pressure (Pₘᵢₙ) and the maximum allowable pressure (Pₘₐₓ) indicate the design tolerances that, if exceeded, may cause failure or damage.

When the pressure (Pₜₐₙₖ) of the detergent supply tank is at the minimum allowable pressure (Pₘᵢₙ) or the lower pressure limit (P_{L}), the open time of the detergent supply valve is the longest. That is, when the pressure (Pₜₐₙₖ) of the detergent supply tank is low, the detergent supply valve is opened for a longer period of time to supply a sufficient amount of cleaning liquid for removing foreign substances.

Meanwhile, when the pressure (Pₜₐₙₖ) of the detergent supply tank is within the pressure lower limit (P_{L}) to the pressure upper limit (P_{U}), the open time of the detergent supply valve is set in inverse proportion to the pressure (Pₜₐₙₖ) of the detergent supply tank. That is, the greater the pressure (Pₜₐₙₖ) of the detergent supply tank, the shorter the open time of the detergent supply valve.

And when the pressure (Pₜₐₙₖ) of the detergent supply tank is at the upper pressure limit (P_{U}) or the maximum allowable pressure (Pₘₐₓ), the open time of the detergent supply valve is set to the shortest duration. In other words, since the pressure (Pₜₐₙₖ) of the detergent supply tank is relatively high, effective cleaning of the sensor can be achieved even if the open time of the detergent supply valve is short.

FIG. 10 schematically illustrates another graph of the open time of the detergent supply valve in relation to the pressure of the detergent supply tank in the method for cleaning a sensor according to one embodiment of the present invention. Since FIG. 10 is similar to FIG. 9, descriptions of the same parts will be omitted.

As shown in FIG. 10, the open time, that is, the ON time (tₒₙ) of the detergent supply valve is adjusted stepwise according to the pressure (Pₜₐₙₖ) of the detergent supply tank. When the pressure (Pₜₐₙₖ) of the detergent supply tank is between the lower pressure limit (P_{L}) and the upper pressure limit (P_{U}), the open time of the detergent supply valve can be set to a constant single value regardless of the pressure (Pₜₐₙₖ) of the detergent supply tank. In other words, this time is less than the open time of the detergent supply valve at the minimum allowable pressure (Pₘᵢₙ) to the lower pressure limit (P_{L}), and greater than the open time of the detergent supply valve at the upper pressure limit (P_{U}) to the maximum allowable pressure (Pₘₐₓ).

Although the embodiments of the present disclosure described above have been explained in detail, the scope of rights of the present disclosure is not limited thereto, and various modifications and improvements by those skilled in the art utilizing the basic concept of the present disclosure defined in the following claims also fall within the scope of the present disclosure.

### Reference Numerals

10. vehicle behavior detection unit

101. IMU, Inertial Measurement Unit

20. detergent supply unit

201. detergent supply tank

203. air compressor

205. check valve

207. dryer

30. detergent spray unit

301, 302, 303. nozzle

40. control unit

401. processor

403. storage

405. memory

407. communication interface

100. sensor cleaning system

200. sensor

2001 and 2003. LiDAR

2002. visual sensor

2004. optical window

2005. camera

2006. motor

2008. bearing

2010. casing

2010a. opening

1000. unmanned vehicle

G. off-road

G10. puddle

V10, V20, V30. detergent supply valve

What is claimed is:

1. A sensor cleaning system for cleaning sensor in operation necessary for the driving of an unmanned vehicle, the sensor cleaning system included in the unmanned vehicle adapted to be designed for off-road driving comprising:
a vehicle behavior detecting unit that continuously measures a pitch, roll, and vertical acceleration of the unmanned vehicle;
a detergent supply unit that intermittently supplies a detergent for cleaning the sensor when the pitch or the roll is changed from a negative value to a positive value within a predetermined time range and the vertical acceleration falls within a predetermined acceleration range; and
a detergent spray unit that is connected to the detergent supply unit and sprays the detergent onto the sensor for cleaning.

2. The sensor cleaning system of claim 1, wherein the predetermined time range is 1 second or less, and the predetermined acceleration range is 10 m/s² to 30 m/s².

3. The sensor cleaning system of claim 1 further comprising a control unit that is respectively connected to and controls the vehicle behavior detecting unit, the detergent supply unit, and the detergent spray unit and
wherein the control unit activates the vehicle behavior detecting unit when automatic mode is input to the control unit.

4. The sensor cleaning system of claim 3, wherein the control unit deactivates the vehicle behavior detecting unit when manual mode is input to the control unit, and wherein
the detergent supply unit intermittently supplies the detergent to the detergent spray unit depending on an input of valve mode and duty mode.

5. The sensor cleaning system of claim 4, wherein the sensor is installed as a plurality of sensors, and
wherein the sensor comprises:
a camera that is installed on the front of the unmanned vehicle; and
a pair of Lidars that are installed on the front of the unmanned vehicle closer to the wheels of the unmanned vehicle than the camera and
wherein the detergent supply unit comprises a plurality of detergent supply valves corresponding to the camera and each of the pair of Lidars, and
wherein the plurality of detergent supply valves are all opened to supply the detergent to clean the camera and the pair of Lidars when the valve mode is full mode.

6. The sensor cleaning system of claim 4, wherein the sensor is installed as a plurality of sensors, and
wherein the sensor comprises:
a camera that is installed on the front of the unmanned vehicle; and
a pair of Lidars installed on the front of the unmanned vehicle closer to the wheels of the unmanned vehicle than the camera, and
wherein the detergent supply unit comprises a plurality of detergent supply valves corresponding to the camera and each of the pair of Lidars, and
wherein detergent supply valves corresponding to the camera are all opened to supply the detergent to clean the camera when the valve mode is basic mode.

7. The sensor cleaning system of claim 5, wherein in the duty mode, a valve closure retention time for at least one of the plurality of detergent supply valves can be selected from a first time, a second time, or a third time, and the first time is shorter than the second time, and the second time is shorter than the third time.

8. The sensor cleaning system of claim 7, wherein the detergent is air, and
wherein the detergent supply unit further comprises:
an air compressor that generates the air; and
a detergent supply tank that supplies the air to the plurality of valves, and
wherein if a pressure in the detergent supply tank drops below a predetermined pressure after the detergent supply valve is opened in the manual mode, the detergent supply valve is closed, and the air compressor replenishes the air in the detergent supply tank until the maximum set pressure of the detergent supply tank is reached.

9. An unmanned vehicle comprising the sensor cleaning system of any one of claim 1.

10. A method for cleaning a sensor in operation necessary for the driving of an unmanned vehicle adapted to be designed for off-road driving and included in the unmanned vehicle comprising a vehicle behavior detecting unit, a detergent supply unit, a detergent spray unit and a control unit, wherein the method comprising:
a first step of activating the vehicle behavior detecting unit;
a second step that the vehicle behavior detecting unit continuously measures pitch, roll, and vertical acceleration of the unmanned vehicle;
a third step that the control unit determines whether the condition is met in which the pitch or the roll is changed from a negative value to a positive value within a predetermined time range and the vertical acceleration falls within a predetermined acceleration range;
a fourth step that the detergent supply unit intermittently supplies the detergent to clean the sensor if the condition is met; and
a fifth step that the detergent spray unit sprays the detergent onto the sensor to clean the sensor.

11. The method for cleaning a sensor of claim 10, wherein in the third step, the predetermined time range is 1 second or less, and the predetermined acceleration range is 10 m/s² to 30 m/s².

12. The method for cleaning a sensor of claim 10, further comprising:
a sixth step of deactivating the vehicle behavior detecting unit when a manual mode is input to the control unit;
a seventh step that the detergent supply unit intermittently supplies the detergent to clean the sensor according to the input of valve mode and duty mode; and
an eighth step that the detergent spray unit sprays the detergent onto the sensor to clean the sensor.

13. The method for cleaning a sensor of claim 12, wherein the sensor comprises:
a camera installed on the front of the unmanned vehicle; and
a pair of Lidars installed on the front of the unmanned vehicle closer to the wheels of the unmanned vehicle than the camera, and
wherein the detergent supply unit comprises a plurality of detergent supply valves corresponding to the camera and each of the pair of Lidars, and
wherein, in the seventh step, the plurality of detergent supply valves are all opened to supply the detergent to the camera and the pair of Lidars if the valve mode is full mode.

14. The method for cleaning a sensor of claim 12, wherein the sensor comprises:
a camera installed on the front of the unmanned vehicle; and
a pair of Lidars installed on the front of the unmanned vehicle closer to the wheels of the unmanned vehicle than the camera, and
wherein the detergent supply unit comprises a plurality of detergent supply valves corresponding to the camera and each of the pair of Lidars, and
wherein, in the seventh step, detergent supply valves corresponding to the camera are opened to supply the detergent to the camera if the valve mode is basic mode.

15. The method for cleaning a sensor of claim 13, wherein in the duty mode, the valve closure retention time for at least one of the plurality of detergent supply valves can be selected from a first time, a second time, or a third time, and the first time is shorter than the second time, and the second time is shorter than the third time.

16. The method for cleaning a sensor of claim 12, wherein the detergent supply unit further comprises:
a detergent supply valve corresponding to the sensor; and
a detergent supply tank that supplies the detergent to the detergent supply valve, and
wherein, in the seventh step, an open time of the detergent supply valve that intermittently supplies the detergent comprises:
a first open time corresponding to an upper limit to a maximum allowable pressure of the detergent supply tank;
a second open time corresponding to a lower limit to an upper limit of the detergent supply tank; and
a third open time corresponding to a minimum allowable pressure to a lower limit of the detergent supply tank, and
wherein the third open time is greater than or equal to the second open time, and the second open time is greater than or equal to the first open time.

17. The method for cleaning a sensor of claim 16, wherein the second open time is inversely proportional to the pressure of the detergent supply tank.

18. The method for cleaning a sensor of claim 16, wherein the second open time is set to be constant.

19. The method for cleaning a sensor of claim 12, wherein the detergent supply unit further comprises:
a detergent supply valve corresponding to the sensor; and
a detergent supply tank that supplies the detergent to the detergent supply valve, and
wherein, in the seventh step, the detergent supply valve is closed if the pressure of the detergent supply tank drops below the lower limit of the detergent supply tank after the detergent supply valve is opened.
